(19) United States
(12) Patent Application Publication
(10) Pub. No.: US 2008/0018119 A1
(43) Pub. Date: Jan. 24, 2008

(54) Fastener for storm shutters

(76) Inventor: Alfred Christopher Langer, New Milford, CT (US)

Correspondence Address: TED PAULDING, 10 PENWOOD LN, WETHERSFIELD, CT, 06109, US

(21) Appl. No.: 11/487,064

(22) Filed: Jul. 13, 2006

(51) Int. Cl. E05C 19/00

(52) U.S. Cl. 292/300

(57) ABSTRACT

Fasteners are provided with an anchor and a cooperating locking element for quick operation on hurricane shutters and the like. The anchor has a slot which receives a locking element with arcuate edges designed for a mechanical advantage in manually inserting the element. Keyhole slots and a keeper provide for removal of the anchor for aesthetic reasons.

### FIELD OF THE INVENTION

This invention relates to fasteners and more particularly to the type of fastener that can be quickly employed to secure a storm shutter in place in the event of a fast approaching hurricane or other storm.

### BACKGROUND OF THE INVENTION

Various types of fasteners have been proposed for quick action in securing storm shutters in place but have not been wholly successful. Evidence of this is to be found in the TV shots we have all seen of homeowners nailing or screwing shutters in position over windows and doors in Florida.

It is the general object of the present invention to provide a fastener for storm shutters which is of the least complicated and least expensive construction so as to be usable in quantity on a large number of shutters, which is readily installed in a simple fast acting operation, which efficiently secures shutters firmly against their associated window and door frames, and which has a low profile and aesthetically pleasing appearance when not in use.

### SUMMARY OF THE INVENTION

In fulfillment of the foregoing object and in accordance with the present invention, a storm shutter fastener is provided with an anchor element adapted for selective attachment to window and door frames and has an outwardly projecting portion with an opening of predetermined size with an inner end portion spaced from the frame a distance slightly less than the thickness of the thinnest shutter to be attached to the frame. An associated locking element is also provided in the form of a wedge having a narrow end portion which can be readily entered into and through the opening in the anchor and an opposite and wider end portion which will not pass through the opening. The intermediate portion of the wedge between the narrow and wider portions gradually increases in width and serves to clamp the shutter to the frame. That is, an inner side edge of the wedge engages the shutter when the wedge is entered as far as possible into the anchor opening and firmly holds the same in position against the frame. The design of the wedge is important to the success of the fastener. That is, the wedge has at least one arcuate side edge for engagement with the shutter and, in accordance with the presently preferred practice, both side edges of the wedge are arcuate with the side opposite the shutter on a substantially smaller radius than the side engaging the shutter. Further, the curves are struck about offset centers to provide for a pivoting action of the wedge and a resulting mechanical advantage during insertion and engagement of the wedge with the shutter.

A secondary locking element in the form of a locking pin cooperates with a series of openings in the wedge to secure the same in its locking position.

As will be seen, the anchor may take various forms and may be fixedly or detachably mounted on the frame.

### DESCRIPTION OF THE DRAWINGS

FIG. 1 of the drawings is an assembled view of a fastener mounted on a frame and holding a thin shutter in place,

FIG. 2 is a view similar to FIG. 1 but with an “L” shaped anchor in a reversed position,

FIG. 3 is a view similar to FIG. 1 but with a straight anchor holding a medium thickness shutter,

FIG. 4 is a view similar to FIG. 3 but with a “Z” shaped anchor holding a shutter slightly thinner than the FIG. 3 shutter,

FIG. 5 is similar to FIG. 4 but with an “L” shaped anchor, which extends through a slot in the shutter,

FIG. 6 is similar to FIG. 2 but with the wedge in a reversed position,

FIG. 7 is a perspective view of the assembled fastener with the anchor projecting through an opening in the shutter,

FIG. 8 is a perspective view similar to FIG. 1,

FIG. 9 is similar to FIG. 7 but with a thin shutter,

FIG. 10 is a perspective view similar to FIG. 2 again with a thin shutter,

FIG. 11 is a perspective view similar to FIG. 3, but with a thin shutter,

FIG. 12 is similar to FIG. 11, but with a detachable anchor,

FIG. 13 is similar to FIG. 10 but with a detachable anchor,

FIG. 14 is sectional a view of a detachable connection of the anchor to the frame,

FIG. 15 is an enlarged exploded view of a keeper and a modified “L” shaped anchor,

FIG. 16 is an exploded view of inter-engaging portions of the keeper and anchor in section,

FIG. 17 is a view of the anchor and keeper of FIG. 15 mounted in operative position as an assembled fastener,

FIG. 18 is a perspective view of a hinged anchor in operative position,

FIG. 19 is a perspective view of the hinged anchor of FIG. 18 in a folded and inoperative position,

FIG. 20 is a top view of an alternative embodiment of the invention with the anchor and wedge connected together for relative pivotal action,

FIG. 21 is a perspective view of the FIG. 20 embodiment of the invention.

FIG. 22 is a top view similar to the FIGS. 1-6 views, but with a wedge having having overlapping slots rather than circular openings, and

FIG. 23 is a perspective view of the latch of FIG. 22

### DETAILED DESCRIPTION OF PREFERRED EMBODIMENTS

Referring particularly to FIGS. 1 and 8, a shutter fastener in accordance with the invention is indicated generally at 10 and comprises an anchor 12 and a wedge 24 which cooperate to securely hold a shutter 22 in firm engagement with the frame 20 adjacent a window or door. The anchor 12 comprises a base portion 14 secured to the frame 20 by conventional screws 18, 18 (one shown) and an outwardly projecting free end portion or arm 16 provided with an opening in the form of a slot 26, FIG. 8.

In accordance with the invention, the slot 26 has its inner end spaced from the frame a distance less than the thickness of the thinnest shutter to be encountered. Thus, inner edge 28 of the wedge 24 engages the thinnest shutter when the wedge is inserted in the slot 26 and urges the same firmly against the frame 20.

The wedge 24 may take a straight-edged tapered configuration but is preferably arcuate along both its inner edge 28 and its outer edge 30 to provide a mechanical advantage in exerting a firm clamping force against the shutter engaged thereby. As shown, each of the edges 28 and 30 takes a presently preferred parti-circular configuration with the edge 28 on a substantially larger radius than the edge 30. As will be apparent, the edges are also struck on radii extending from centers substantially offset from each other so that a clockwise pivoting movement of the wedge between the outer end of the slot 26 and the edge 30 in FIG. 1 results in increasing pressure by the edge 28 on the shutter 22. The resulting mechanical advantage enables the wedge to be manipulated manually under slight force for rapid and easy insertion to the operative position shown. Conversely, a manually exerted counter-clockwise force results in ready removal of the wedge. The foregoing quick insertion and resulting locking action is of course of the utmost importance in the event of a rapidly approaching hurricane.

A final feature of the fastener resides in the provision of a locking pin 32 and a cooperating series of small openings 34, 34 formed in the wedge 24. As will be obvious, the pin 32 may be entered selectively in the openings 34, 34 as required to secure the wedge in locking position holding an adjacent shutter against its frame. The number of openings 34, 34 may of course vary, nine (9) being shown the openings 34, 34 are sequentially spaced as required to hold the wedge 24 for shutters of various thicknesses.

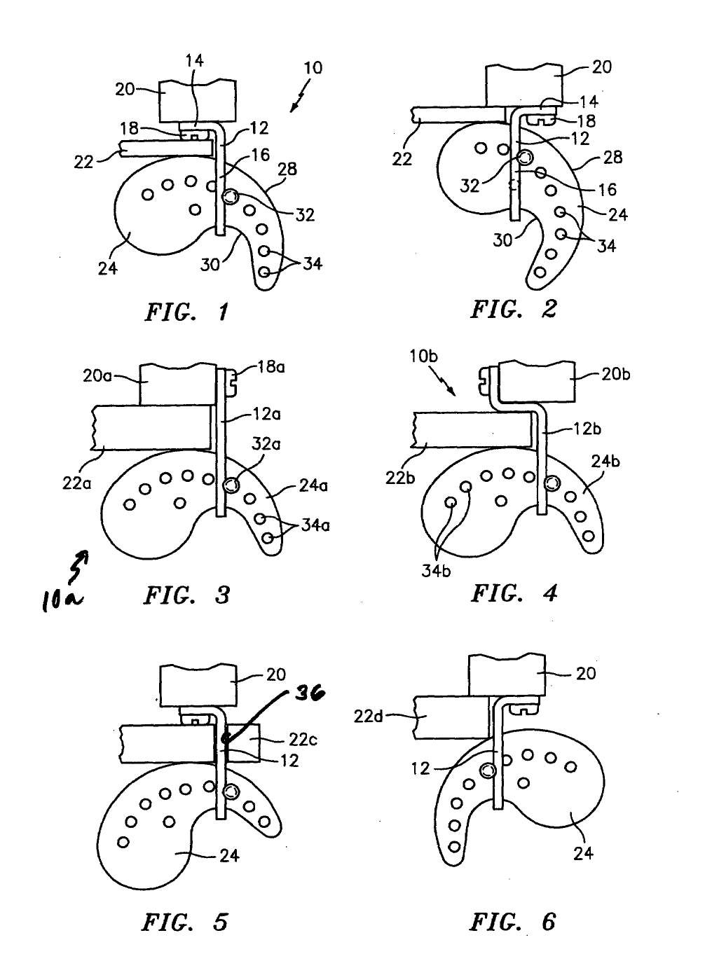

FIG. 2 illustrates an alternative arrangement of the FIG. 1 parts wherein the anchor 12 is reversed with the screws 18,18 exposed rather than engaged behind the shutter as in FIGS. 1 and 8. Accidental or unintended loosening of the screws may of course be best prevented with the FIGS. 1, 8 arrangement.

FIG. 3 illustrates a linear rather than an “L” shaped anchor element at 12a, a base portion of the anchor being attached to a side surface rather than a front surface of the frame 20a. Shutter 22a held in place by the fastener 10a is substantially thicker than the shutter 22 of FIG. 1.

The fastener 10b of FIG. 4 is substantially the same as the preceding fastener except for the provision of a “Z” shaped anchor 12b which may be employed when it is convenient to attach the same to an inner side surface of frame 20b.

FIGS. 5 and 6 respectively show FIGS. 1 and 2 fasteners with shutters 22c and 22d substantially thicker than the shutter 22. The fasteners of the invention are designed to accommodate shutters of all presently known thicknesses.

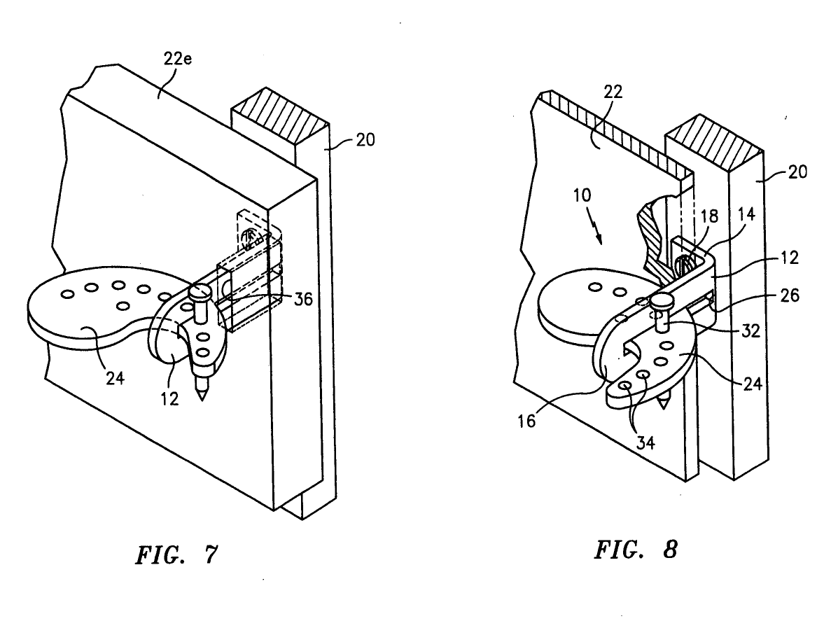

FIGS. 5 and 7 illustrate a fastener which may be identical in all respects with the FIGS. 1 and 8 fastener in association with a shutter 22c and 22e which are provided with a slot 36 for receiving the anchor 12. Vertical slot sidewalls of course engage the anchor and positively prevent lateral sliding movement of the shutter and the fastener need only secure the shutter against the frame for movement toward and away from the latter.

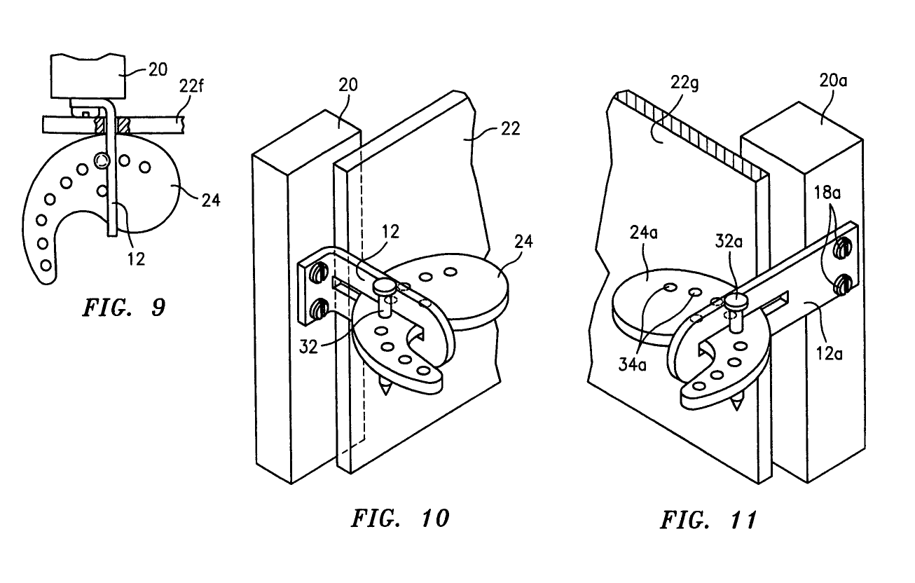

FIG. 9 is similar to FIGS. 5 and 7 but with a thin shutter 22f.

FIG. 10 is a perspective view of the FIG. 2 fastener and shutter.

FIG. 11 is a perspective view of the FIG. 3 fastener with a shutter 22g somewhat thinner than the shutter 22.

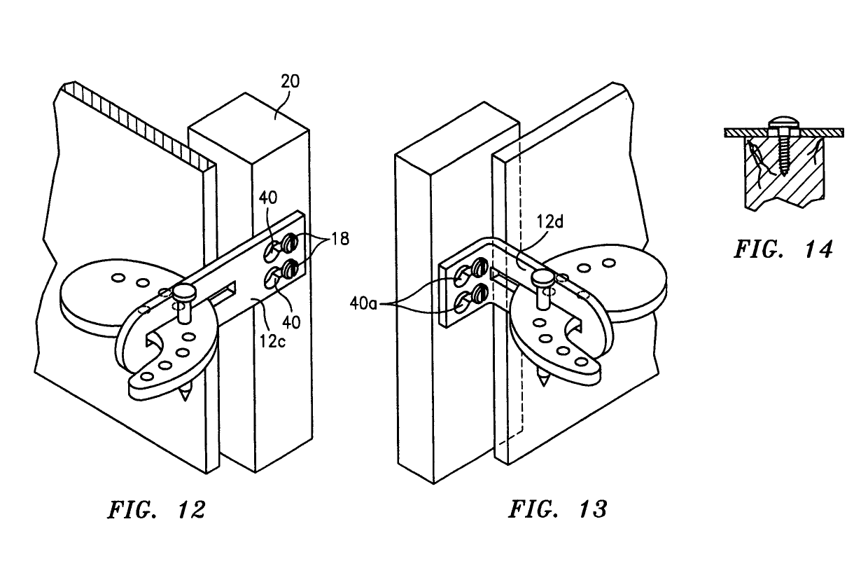

FIG. 12 is substantially identical with FIG. 11 except for the provision of a detachable linear anchor 12c with a pair of keyhole slots 40, 40 which respectively receives screws 18, 18, shown in a tightened condition in FIG. 12 securing the anchor to the frame 20. Obviously, the screws 18, 18 may be withdrawn slightly as shown in FIG. 14 and entered or withdrawn through the larger portions of the keyhole slots for the detachable connection and removal of the anchor 12c from the frame 20. With the anchor removed from the frame 20 the aesthetics of the window or door are of course enhanced.

FIG. 13 is substantially identical with FIG. 2 except for the provision of an “L” shaped anchor 12d with a pair of keyhole slots 40a, 40a which cooperate with screws 18, 18 in the same manner as the slots 40, 40 and screws 18, 18 in FIG. 12.

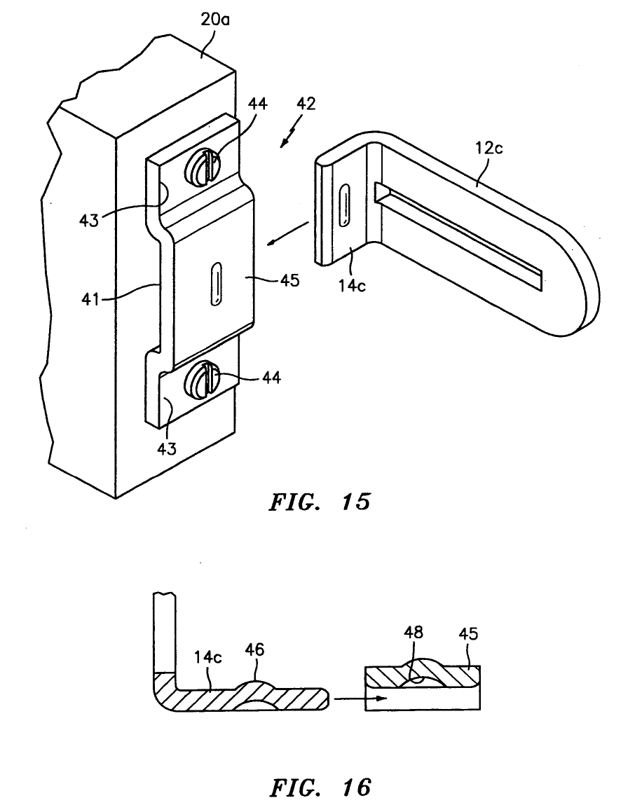

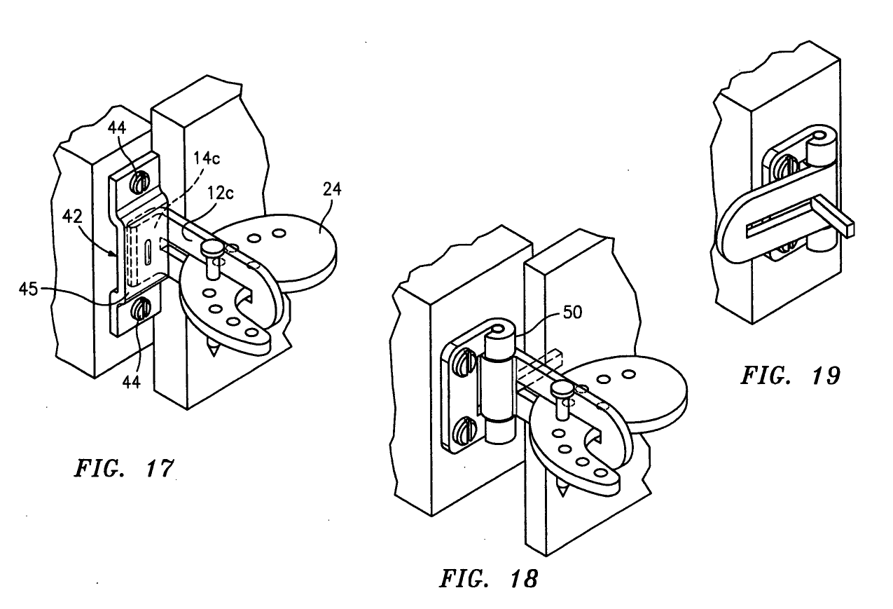

FIG. 15 and 16 illustrate a keeper indicated generally at 42 which has opposite end flanges 43, 43 provided with holes for screws 44, 44 which attach the keeper to a frame 20a. A forwardly or outwardly bent central portion 45 of the keeper creates a lateral slot 41 designed to slideably receive a base portion 14c of an anchor 12c with a rear portion of the base engaging the frame 20a. When the base portion 14c is fully entered in the slot 41, a boss 46 thereon enters a detent 48 formed in the keeper and removeably secures the base portion in the keeper slot. Thus, the anchor 12c will be held in its operative position and may thereafter be readily removed manually for enhanced aesthetics of the frame.

In FIG. 17, the keeper 42 is shown in association with anchor 12c in a fastener assembly in the manner of the preceding fasteners.

FIGS. 18 and 19 show a fastener 10g with an anchor 12g which is hinged at 50 so as to be folded back against the frame when not in use.

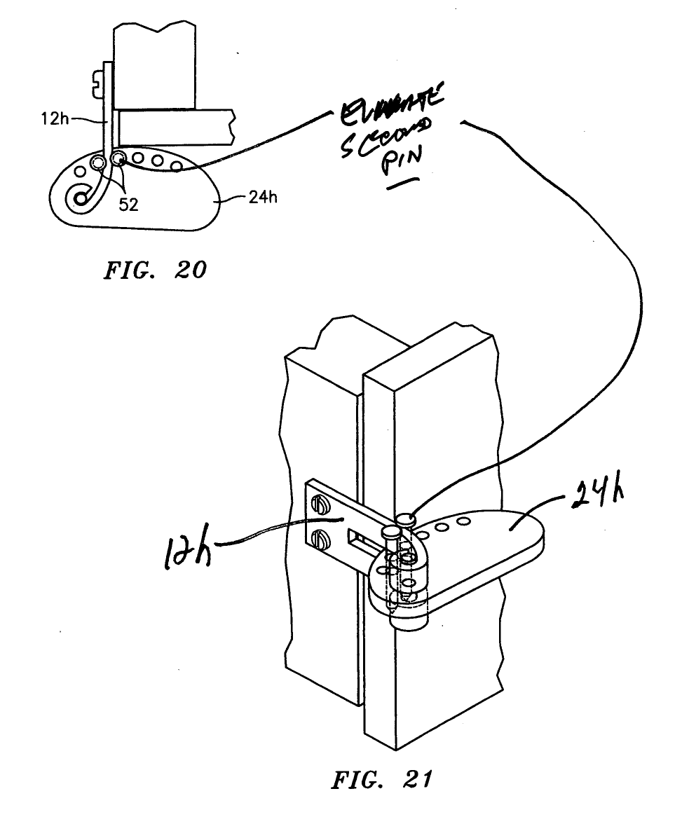

FIGS. 20 and 21 show a fastener 10h which has a locking element 24h hingedly connected to an anchor 12h, a pair of locking pins 52, 52 being provided for securing the element 24h in locking position.

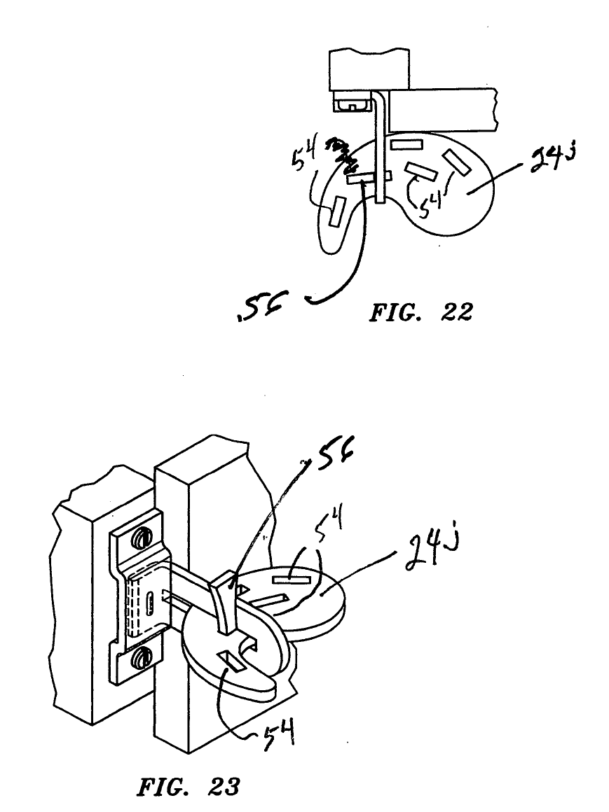

FIGS. 22 and 23 illustrate a fastener having a wedge 24j provided with overlapping slots 54, 54 for receiving a wedge shaped locking pin 56. This alternative arrangement may be somewhat more secure than those with the circular openings receiving a cylindrical pin.

As will be apparent from the foregoing, fasteners have been provided which are of simple and inexpensive construction and which in a quick and easy operation can be installed to positively secure shutters of various thicknesses in position. Moreover, aesthetic features are fully taken into consideration when the fasteners are not in use.

1. A fastener for storm shutters and the like comprising an anchor element adapted for selective attachment to window and door frames and having an outwardly projecting portion with an opening of predetermined size with its inner end portion spaced from the frame a distance less than the thickness of the thinnest shutter to be attached to the frame, and a locking element in the form of a wedge having a narrow end portion which can be readily entered into and through the opening in the anchor and an opposite wider end portion which will not pass through the opening, the intermediate portion between said narrow and wider portions becoming gradually wider in progression from: said narrow to said wide portion, and said wedge when entered in said opening having an inner side edge which engages shutters of various thickness and firmly holds the same in position against the frame in a clamping action.

2. A fastener for storm shutters as set forth in claim 1 wherein at least the inner edge of the locking wedge has an arcuate edge for engagement with the shutter.

3. A fastener for storm shutters as set forth in claim 2 wherein both sides of the locking wedge are arcuate to provide the wedge with a somewhat kidney shape.

4. A fastener as set forth in claim 1 wherein a secondary locking element is provided to secure the first locking element in firm engagement with the shutter.

5. A fastener as set forth in claim 4 wherein the first locking element is provided with a series of small openings, and wherein the secondary locking element takes the form of a locking pin for co-operatively locking the first element in firm engagement with the shutter when selectively entered in an opening in the first locking element and engaging the anchor.

6. A fastener as set forth in claim 1 wherein the anchor element takes an “L” shape viewed from the side with the base of the “L” attachable to the frame and the free end portion of the “L” projecting outwardly and having the aforesaid opening formed therein.

7. A fastener as set forth in claim 6 wherein the base of the anchor in fixedly screwed to the frame.

8. A fastener as set forth in claim 6 wherein the anchor is hinged at the junction of its base and free end portion.

9. A fastener as set forth in claim 1 wherein the anchor takes a generally “Z” shape viewed from the side.

10. A fastener as set forth in claim 1 wherein the anchor takes a linear configuration when viewed from the side.

11. A fastener as set forth in claim 1 wherein the anchor is secured to the frame by conventional wood screws with the anchor having an enlarged hole and a communicating smaller hole for each screw, the anchor thus being readily detached from the frame.

12. A fastener as set forth in claim 6 wherein a low profile keeper element is provided and fixedly attached to the frame, the keeper element having a offset section which defines a slot for slidably receiving the base of the “L” shaped anchor and removably securing the same in operating position.

13. A fastener as set forth in claim 12 wherein a small boss-detent connection is provided between the keeper and base of the anchor.

14. A fastener as set forth in claim 1 wherein the anchor and locking element are pivotally connected together for entry and removal of the latter from the opening in the former.
